(19) United States
(12) Patent Application Publication
(10) Pub. No.: US 2009/0003801 A1
(43) Pub. Date: Jan. 1, 2009

(54) Method and system for optical characterization of optical crystallization

(76) Inventors: Thomas Wenzel, Goettingen (DE); Frank Simon, Goettingen (DE)

Correspondence Address: STALLMAN & POLLOCK LLP, 353 SACRAMENTO STREET, SUITE 2200, SAN FRANCISCO, CA, 94111, US

(21) Appl. No.: 11/823,613

(22) Filed: Jun. 28, 2007

(51) Int. Cl. H04N 5/00

(52) U.S. Cl. 386/117

(57) ABSTRACT

Systems and methods for optical characterization of crystallization processes, especially SLS crystallization processes, are disclosed. A substrate is illuminated with light and images are acquired by image acquisition means. The images of the processed areas are fed to a control system. The control system works color selectively by either using color selective image processing of color images or by the use of colored light and black and white image acquisition means.

### FIELD OF THE INVENTION

The present invention relates to techniques for controlling crystallization processes and, in particular, to methods and systems for optical control of sequential lateral solidification (SLS) crystallization processes.

### BACKGROUND OF THE INVENTION

Thin film transistor (TFT) technology is the basis for high-resolution, high-performance liquid crystal display (LCD) screens, providing the best resolution of the various flat panel display technologies that are currently available. Advanced thin film transistor technology is based upon polycrystalline silicon.

Polycrystalline silicon may be formed using laser recrystallization techniques, such as excimer laser annealing. In excimer laser annealing, a high-power laser beam is scanned over the surface of a substrate that is coated with amorphous silicon. The amorphous silicon is heated, melts and then recrystallizes to form polycrystalline silicon.

A more recently introduced laser recrystallization technique is 2-shot sequential lateral solidification (SLS). In a typical application of this technique, a two-dimensional mask pattern is imaged upon the amorphous silicon film using an imaging lens. Only the irradiated areas of the amorphous silicon melt and recrystallize. By repetitive irradiation of different areas, the entire substrate silicon film can be recrystallized in the desired pattern. The quality of the resulting patterned polycrystalline silicon film exceeds that of excimer laser annealing processed material in various parameters.

Thin film transistor technology requires extremely high quality processes and high process speeds. These requirements place great demands on the process control of SLS system. It is particularly important to be able to control the crystallization process continuously to avoid defect structures in the recrystallized areas.

One conventional technique for controlling recrystallization processes is the use of off-situ incident light microscopes with color charge coupled device (CCD) cameras. The inspected area is illuminated in light field or in dark field. Different phases of crystallization show different colors and contrasts in the image. Amorphous areas of a silicon substrate usually exhibit a red/orange color, whereas crystallized areas exhibit a bright orange/yellow color. One drawback of this conventional method is that it is difficult to automate; the images usually must be inspected by a qualified person.

There are a number of challenges associated with an optical approach to recrystallization control. First, the inspected structures of recrystallization are rather small. Deviations from the predetermined structures are even smaller. High quality optical systems are needed to detect those deviations. In addition, the inspected areas are comparatively small with respect to the size of the entire substrate. As mentioned above, a high inspection rate is necessary to gain effective control over the recrystallization process.

The object of the present invention is, therefore, to provide methods and systems for optical crystallization control that overcome the drawbacks of the known methods and systems and that enable fast and reliable control with equipment that is cheaper and easier to use.

### SUMMARY OF THE INVENTION

Methods and systems in accordance with the present invention enable accurate and reliable inspection of recrystallization processes. The invention is generally based upon optical control methods.

One aspect of the invention relates to a method for characterization of a crystallization process with optical methods, in which a processed substrate is illuminated with polychromatic light. An image of the illuminated substrate is recorded using an image acquisition system that is capable of acquiring color images. The recorded image is then transmitted to an image processing unit that analyzes the image color selectively. This enables faster scans and more reliable results than analyzing color images with conventional methods. The image processing unit analyzes the green and/or the blue channel of the recorded image separately. It has been found that different stages of recrystallization show different optical properties, especially in the green and blue channel of a color image. The red channel exhibits only very small contrasts. Limiting the analysis to the green and/or blue channel saves calculation resources and improves the contrast between the different phases. It is particularly advantageous to further optimize the contrast of the blue and/or the green channel of the image. The regions of interest, particularly the borders between crystallized areas and amorphous areas and uncrystallized spots in the areas to be crystallized, are more visible after contrast optimization.

Another aspect of the invention relates to a method for characterization of a crystallization process with optical methods in which a crystallizing substrate is illuminated with a substantially monochromatic light or a narrow band polychromatic light. An image of the substrate is recorded using an image acquisition system and the recorded image is transmitted to an image processing unit. The image processing unit analyzes the recorded image. This aspect of the invention enables the use of black and white cameras that usually have a higher resolution than color cameras, since color cameras usually use three sensor elements for one pixel of an image. Furthermore, black and white cameras are cheaper than color cameras because the image sensor technology is less complex.

It is particularly advantageous to use light emitting diodes for illumination. Diodes which irradiate blue and green light have shown best results. The use of color light diodes enables faster switching between different illumination colors than the use of, for example, different color filter elements in front of white light or broad band illumination systems.

It is particularly advantageous for both aspects of the invention to automatically recognize the image in the image processing unit.

The aforementioned methods are especially suitable for inspecting SLS crystallization processes.

Another aspect of the invention relates to an SLS system that includes an optical control system. The control system further includes an illumination system to illuminate a substrate, image acquisition means to record images of the illuminated substrate, and an image processing unit to analyze the acquired images from the image acquisition system. Preferably, the image acquisition system is a color image acquisition system. The illumination system is polychromatic and the image processing unit is capable of color selective analysis of the recorded image. In an alternative embodiment, the image acquisition system is a black and white image acquisition system. The illumination system irradiates monochromatic or narrow band polychromatic light.

Since the characterization technique of the present invention can be automated and works without human interaction, it can be used as a base for automatized system performance monitoring or control of the SLS process.

The features and advantages of the various aspects of the present invention will be more fully understood and appreciated upon consideration of the following detailed description of the invention and the accompanying drawings, which set forth illustrative embodiments in which the concepts of the invention are utilized.

### BRIEF DESCRIPTION OF THE DRAWINGS

FIG. 1 shows an image of an SLS treated substrate acquired with a color camera.

FIG. 2 shows the red channel of the image of FIG. 1.

FIG. 3 shows the green channel of the image of FIG. 1 and a corresponding intensity profile.

FIG. 4 shows the blue channel of the image of FIG. 1 and a corresponding intensity profile.

FIG. 5 shows a contrast optimized version of the blue channel of the image of FIG. 1.

FIG. 6 shows a schematic representation of a preferred embodiment of a crystallization process control system in accordance with the concepts of the present invention.

### DETAILED DESCRIPTION OF THE INVENTION

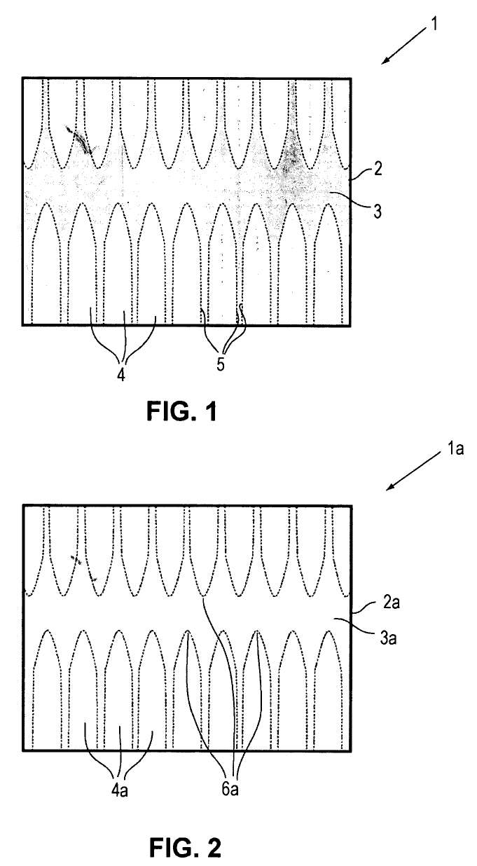

FIG. 1 shows an image 1 of a partially sequential lateral solidification (SLS) treated silicon substrate 2 which has been acquired utilizing a color camera. The substrate 2 exhibits amorphous silicon in area 3 of the substrate 2. The substrate 2 further shows recrystallized substrate (all of what is not area 3) protrusion lines 4 and borders of the recrystallized substrate in which the substrate has been treated by an SLS process in a known way.

For quality purposes, it is important that the profile of the recrystallized substrate remains homogeneous over the full substrate area. That is, position and width of the protrusion lines 4 and the borders 5 should not change. Inhomogenities will lead to visible deviations of cell performance, e.g., in TFT displays, and, therefore, are not desirable. (The black bent line in the top left part of FIGS. 1-5 is a dust particle.)

FIG. 2 shows the red channel of the color image 1 of FIG. 1. The red channel of the image 1a contains very little information concerning the critical areas of the substrate 2a. The image 1a is very light and does not show much contrast. The end portions 6a of the protrusions 4a have nearly the same brightness as area 3a of the amorphous silicon.

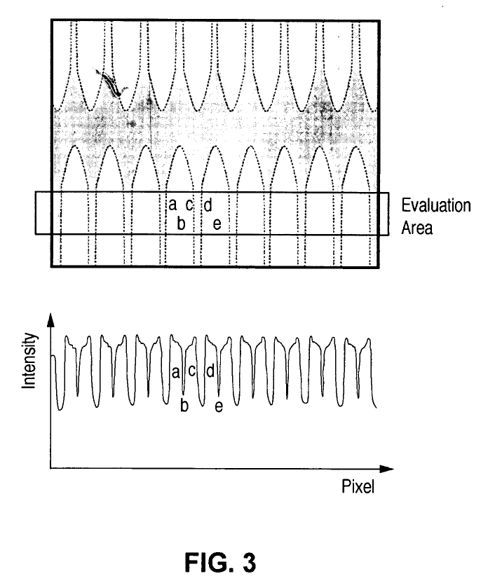

FIG. 3 shows the green channel of the image of FIG. 1 and a corresponding intensity profile. In this case, the contrast between the amorphous area 3b and the recrystallized silicon 4b of the green image 1b is much higher than in the red channel image 1a as shown in FIG. 2 and higher than in the full color image 1 as shown in FIG. 1. Since the boundaries are much more visible for the green channel, an automatic image recognition system is able to identify the different areas 3b and 4b with higher precision. Due to the high contrast, the following features can be determined by computer algorithm: (a) left border of recrystallized area; (b) position of protrusion line; (c) right border of recrystallized area; (d) left border of next recrystallized area; and (e) next position of protrusion line. From this information, certain process characterization values can be calculated, e.g. (c−a) equals the width of the recrystallized area, (d−c) equals the spacing width, (b−a)/(c−b) equals the centering of the protrusion line. Those skilled in the art will appreciate that, with similar extraction schemes, other characterization values, such as corner diameters of the tip areas, can be extracted. Automated processing permits characterization of large areas, providing calculated values, rather than manual interpretations of microscope pictures, that can be the basis for automated system control.

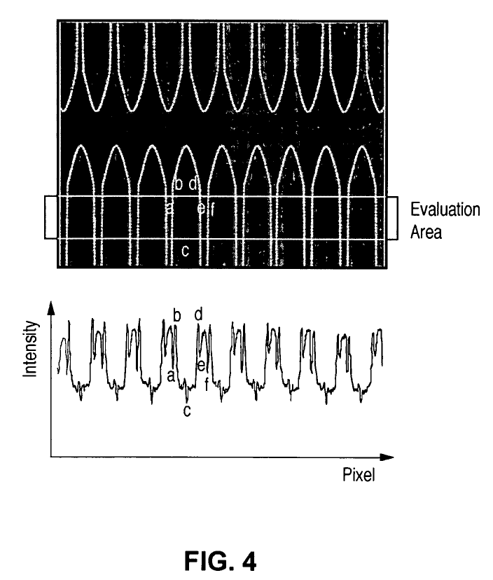

FIG. 4 shows the blue channel of FIG. 1 and a corresponding intensity profile. In this case, the borders 5c of the blue channel image 1c are clearly distinguishable from the main recrystallized areas 4c and the amorphous area 3c. Therefore, the blue channel 1c of the full color image 1, as shown in FIG. 4, is ideal to investigate the borders 5c, whereas the green channel 1b of the full color image 1, as shown in FIG. 3, is ideal to investigate the area between amorphous area 3c and recrystallized protrusions 4c. Again, due to the high contrast, the following features can be determined by computer algorithm: (a) left border of left recrystallization border, (b) right border of left recrystallization border, (c) center of protrusion line, (d) left border of right recrystallization border, (e) right border of right recrystallization border, (f) left border of next left recrystallization border. As discussed above, automated processing permits characterization of large areas, providing calculated values that can be used as the basis for automated system control.

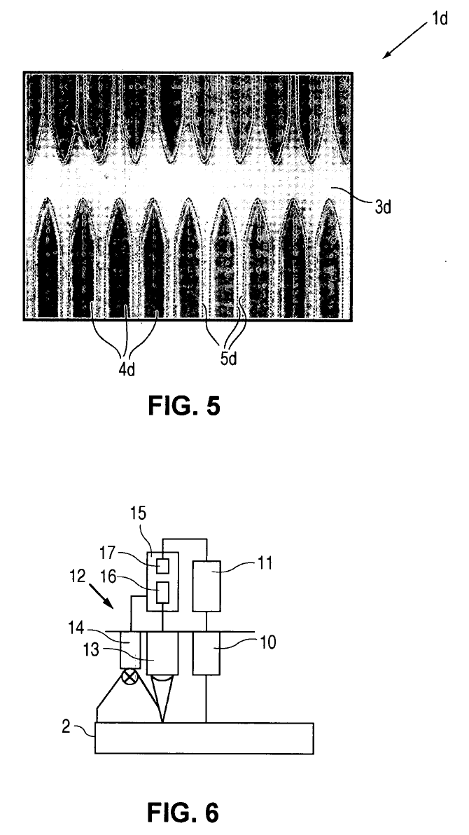

FIG. 5 shows a contrast optimized version 1d of the blue channel of the full color image of FIG. 1. Due to the contrast optimization, all areas 3d, 4d, 5d are clearly visible and distinguishable. The parameters of contrast optimization can be calibrated in advance; continuous contrast optimization is not necessary.

The color channels shown in FIGS. 2-5 are similar to images that are achieved using monochromatic or narrow band polychromatic light of a respective wavelength. Thus, the use of a black and white camera in combination with colored light is sufficient to analyze the images.

FIG. 6 shows a schematic representation of a preferred embodiment of the inventive system. Since the schematic representations of both embodiments of the inventive system, white light with color camera or colored light with black and white camera, are identical, they are described utilizing the one FIG. 6 schematic representation.

Substrate 2 is treated by an SLS imaging unit 10. The SLS imaging unit 10 is controlled by SLS control unit 11. An image recognition system 12 comprises a camera 13, an illumination system 14 and a calculation unit 15. The calculation unit 15 comprises an image processing unit 16 and an image recognition unit 17. The calculation unit 15 is connected to an SLS control unit 11.

According to a first aspect of the present invention, the illumination system 14 illuminates the inspected area of the substrate 2 with polychromatic light and camera 13 is a color camera, such as, for example, a standard Sony XC-555P CCIR video camera.

According to a second aspect of the invention, the illumination system 14 illuminates the inspected area with monochromatic or narrow band polychromatic light and the camera 13 is a black and white camera, such as, for example, a standard Sony XC-ST50CE CCIR video camera. The illumination system 14 may be a switchable color illumination system or may comprise separate illuminators means for each color. For example, color light emitting diodes have shown good results. The use of a white light source combined with color filters would be less advantageous, since it is easier to switch on and off a light diode than to mechanically move a color filter. In the most preferred embodiment of the invention, images are taken of the same area with different illumination colors.

The image taken by the camera 13 is transmitted to the calculation unit 15. Calculation unit 15 can be a general purpose desk top computer or a similar data processing system. Image processing unit 16 of calculation unit 15 processes the image in different steps. If the image is a color image, the color information of the image is separated into its red, blue and green color channels and the red channel is discarded. Then, the blue and the green channel images are contrast optimized. If the image is a black and white image, the calculation unit 15 recognizes the illumination color in which the image has been taken and the image is contrast optimized depending upon the illumination color. Those skilled in the art will be familiar with commonly available image processing units and contrast optimization techniques that can be used in this application.

The processed images are transmitted to the image recognition system 16 which checks the areas of protrusion. Critical points of the protrusions 4 are the boundaries between the amorphous areas 3 of the silicon and the recrystallized areas 4 of the substrate 2. Further, it is important that the ridge 5 of the protrusion is intact. A constant line thickness and a continuous line indicate usable structures. The image recognition system 16 further checks to determine if spots of amorphous silicon are in the areas of protrusion 4. The results of the image recognition are fed to the SLS control system 11 in order to optimize the SLS process, e.g., by readjusting the focus of the SLS system 10.

It should be understood that the particular embodiments of the invention described above have been provided by way of example and that other modifications may occur to a person skilled in the art without departing from the spirit and scope of the invention as expressed in the appended claims and their equivalents.

What is claimed is:

1. A method of characterizing a crystallization process, the method comprising:
illuminating a crystallizing substrate with polychromatic light;
recording an image of the illuminated substrate;
transmitting the recorded image to an image processing unit;
utilizing the image processing unit to color selectively analyze the transmitted image.

2. The method of claim 1, and wherein the image processing unit separates the green and/or the blue channel of the transmitted image.

3. The method of claim 2, and wherein the color selective analyzing includes a step of contrast optimization.

4. The method of claim 1, and wherein the transmitted image is automatically recognized by the image processing unit.

5. The method of claim 4, and wherein boundaries between amorphous areas and crystallized areas of the transmitted image are recognized in the step of image recognition.

6. The method of claim 1, and wherein results of image processing are provided to a crystallization control system.

7. The method of claim 1, and wherein the crystallization process is a SLS crystallization process.

8. A method for optical control of a crystallization process, the method comprising:
illuminating a crystallizing substrate with a substantially monochromatic light or a narrow band polychromatic light;
recording a color image of the substrate utilizing an image acquisition system;
transmitting the recorded color image to an image processing unit;
analyzing the transmitted color image in the image processing unit.

9. The method of claim 8, and wherein the step of image analysis includes a step of contrast optimization.

10. The method of claim 8, and wherein the transmitted color image is automatically recognized in the image processing unit.

11. The method of claim 8, and wherein illumination of the substrate is accomplished using at least one color light diode.

12. The method of claim 11, and wherein at least first and second light diodes are used that exhibit different spectra.

13. The method of claim 12, and wherein the first and second light diodes are green and blue light emitting diodes, respectively.

14. The method of claim 10, and wherein boundaries between amorphous areas and crystallized areas of the substrate are recognized in the step of image recognition.

15. The method of claim 8, and wherein the crystallization process is a SLS crystallization process.

16. The method of claim 8, and wherein results of the image processing are provided to a crystallization control system.

17. An SLS system, including an optical control system, the optical control system comprising:
an illumination system that illuminates a substrate;
an image acquisition system that acquires color images from the illuminated substrate;
an image processing unit that analyzes the acquired color images.

18. The SLS system of claim 17, and wherein the illumination system exhibits polychromatic light, the image acquisition system acquires color image information, and the image processing unit is capable of color selective analysis of the recorded color image.

19. The SLS system of claim 18, and wherein the image acquisition system comprises a color CCD camera.

20. The SLS system of claim 17, and wherein the illumination system exhibits monochromatic or narrow band polychromatic light.

21. The SLS system of claim 20, and wherein the image acquisition system comprises a monochromatic camera, especially a CCD camera.

22. The SLS system of claim 21, and wherein the monochromatic camera comprises a CCD camera.

23. The SLS system of claim 20, and wherein the SLS system further comprises at least one other illumination system, wherein each illumination system of the SLS system shows different spectra.

24. The SLS system of claim 17, and wherein the SLS system further comprises a controller that controls the crystallization process according to the result of the image processing.
